(19) United States
(12) Patent Application Publication
(10) Pub. No.: US 2014/0132070 A1
(43) Pub. Date: May 15, 2014

(54) RACK AND POWER CONTROL METHOD THEREOF

(71) Applicants: INVENTEC (PUDONG) TECHNOLOGY CORPORATION, (US); INVENTEC CORPORATION, Taipei City (TW)

(72) Inventors: Hao-Yen Kuan, Taipei City (TW); Shu-Yen Wang, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/846,434

(22) Filed: Mar. 18, 2013

(30) Foreign Application Priority Data
Nov. 15, 2012 (CN) 201210458942.5

(51) Int. Cl. H02J 4/00

(52) U.S. Cl. CPC H02J 4/00
USPC 307/29

(57) ABSTRACT

A power control method for a rack having a plurality of nodes is used for turning on a plurality of main power supplies and standby power supplies in pairs according to an actual number of power supply needed to be turned on. A total power consumption value for the nodes is calculated according to power information of the nodes. A number of power supply needed to be turned on is calculated according to the total power consumption value and a maximum power value for one power supply to obtain the actual number and is smaller than the actual number. When the main power supplies supply operating voltages to the nodes, the standby power supplies do not supply the operating voltages to the nodes. An input source received by the main power supplies is different from that received by the standby power supplies.

### CROSS-REFERENCE TO RELATED APPLICATIONS

This non-provisional application claims priority under 35 U.S.C. §119(a) on Patent Application No(s). 201210458942.5 filed in China on Nov. 15, 2012, the entire contents of which are hereby incorporated by reference.

### BACKGROUND OF THE INVENTION

1. Technical Field of the Invention

This disclosure relates to a power control method, more particularly a rack and the power control method thereof.

2. Description of the Related Art

In general, the individual performance and effectiveness of current servers are emphasized widely. Thus, a server designed on the basis of this concept requires the labor division and the independent operation. In other words, each server node dynamically adjusts its energy consumption according to its own situation and needs, to balance its energy conservation and performance.

However, under this principle, every server node only performs the labor division among the server nodes, but can not cooperate with each other. This always causes that all the server nodes in a data center operate under a similar performance condition, and then causes the excessive power consumption. Moreover, when the server operates normally, all power supplies in the server are turned on to supply the required power to the server nodes.

However, during the practical operation of the server, not all server nodes are under the full load condition. This causes the excessive power consumption.

### SUMMARY OF THE INVENTION

This disclosure relates to a power control method of a rack having a plurality of nodes. The power control method comprises following steps. Power information of each of the plurality of nodes is received. A total power consumption value for the plurality of nodes is calculated according to the power information. A number of power supply needed to be turned on is calculated according to the total power consumption value and a maximum power value of one power supply. An actual number of power supply needed to be turned on is calculated according to the number of power supply needed to be turned on. The actual number of power supply needed to be turned on is greater than the number of power supply needed to be turned on. Main and standby power supplies are turned on according to the actual number of power supply needed to be turned on.

In one embodiment, the number of power supply needed to be turned on is N, the actual number of power supply needed to be turned on is N+1, and N is an integer greater than 1.

In one embodiment, the power control method further comprises following steps. Power-good signals generated by the turned-on main power supplies are received. Whether any of the turned-on main power supplies malfunctions is determined according to the power-good signals. A corresponding number of other main power supplies are turned on if at least one turned-on main power supply malfunctions.

In one embodiment, the step of defining the corresponding number to turn on the other main power supplies comprises following steps. Whether the at least one turned-on main power supply malfunctioning is the last one of the main power supplies. The corresponding number of other main power supplies are turned on if the at least one turned-on main power supply is not the last one of the main power supplies. A corresponding number of the turned-on standby power supplies are controlled to supply the operating voltages to the plurality of nodes if the at least one turned-on main power supply malfunctioning is the last one of the main power supplies.

In one embodiment, before the step of determine whether the at least one turned-on main power supply malfunctioning is the last one of the main power supplies, the method further comprises following steps. Whether all of the turned-on main power supplies malfunction is determined. A corresponding number of the turned-on standby power supplies are controlled to supply the plurality of nodes with the operating voltages if all of the turned-on main power supplies malfunction. The step of determining whether the at least one turned-on power supply malfunctioning is the last one of the main power supplies, is performed if all of the turned-on main power supplies malfunction.

This disclosure relates to a rack, which comprises a plurality of main power supplies, a plurality of standby power supplies, a plurality of nodes, a rack management controller and a control unit. The plurality of main power supplies are used for supplying operating voltages respectively. The plurality of standby power supplies are used for supplying the operating voltages respectively. The input source received by the plurality of main power supplies is different from that received by the plurality of standby power supplies. The plurality of nodes are used for providing their power information respectively. The rack management controller is coupled with the plurality of nodes and used for receiving the power information to calculate a total power consumption value, for calculating a number of power supply needed to be turned on, according to the total power consumption value and a maximum power value for one power supply, and for calculating an actual number of power supply needed to be turned on according to the number of power supply needed to be turned on. The actual number of power supply needed to be turned on is greater than the number of power supply needed to be turned on. The control unit is coupled with the rack management controller, the plurality of main power supplies and the plurality of standby power supplies, for acquiring the actual number of power supply needed to be turned on, and for generating a plurality of control signals according to the actual number of power supply needed to be turned on, so as to turn on the plurality of main power supplies and the plurality of standby power supplies in pairs. When the turned-on main power supplies supply the operating voltages to the plurality of nodes, the turned-on standby power supplies do not supply the operating voltages to the plurality of nodes.

In one embodiment, the number of power supply needed to be turned on is N, the actual number of power supply needed to be turned on is N+1, and N is an integer greater than 1.

In one embodiment, the main power supplies and the standby power supplies respectively output a power-good signal to the control unit after being turned on. The control unit then determines whether any of the turned-on main power supplies malfunctions, according to the power-good signals. The control unit turns on a corresponding number of the rest of the plurality of main power supplies if at least one of the turned-on main power supplies malfunctions.

In one embodiment, the control unit further determines whether the at least one turned-on power supply malfunctioning is the last one of the plurality of main power supplies. The control unit turns on a corresponding number of the rest of the plurality of main power supplies if the at least one turned-on power supply malfunctioning is not the last one of the plurality of main power supplies. Otherwise, the control unit controls a corresponding number of the turned-on standby power supplies to supply the plurality of nodes with the operating voltages.

In one embodiment, the control unit further determines whether all of the turned-on main power supplies malfunction. The control unit controls a corresponding number of the turned-on standby power supplies to supply the plurality of nodes with the operating voltages if all of the turned-on main power supplies malfunction. Otherwise, the control unit determines whether the at least one turned-on power supply malfunctioning is the last one of the plurality of main power supplies. In this way, the control unit decides whether to turn on a corresponding number of the rest of the plurality of main power supplies, or to control a corresponding number of the turned-on standby power supplies to supply the plurality of nodes with the operating voltages.

### BRIEF DESCRIPTION OF THE DRAWINGS

The present disclosure will become more fully understood from the detailed description given herein below for illustration only and thus does not limit the present disclosure, wherein:

FIG. 1 is a schematic diagram for a rack in this disclosure.

FIG. 2 is a flowchart of a power control method of a rack in this disclosure.

FIG. 3 is another flowchart of a power control method of a rack in this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

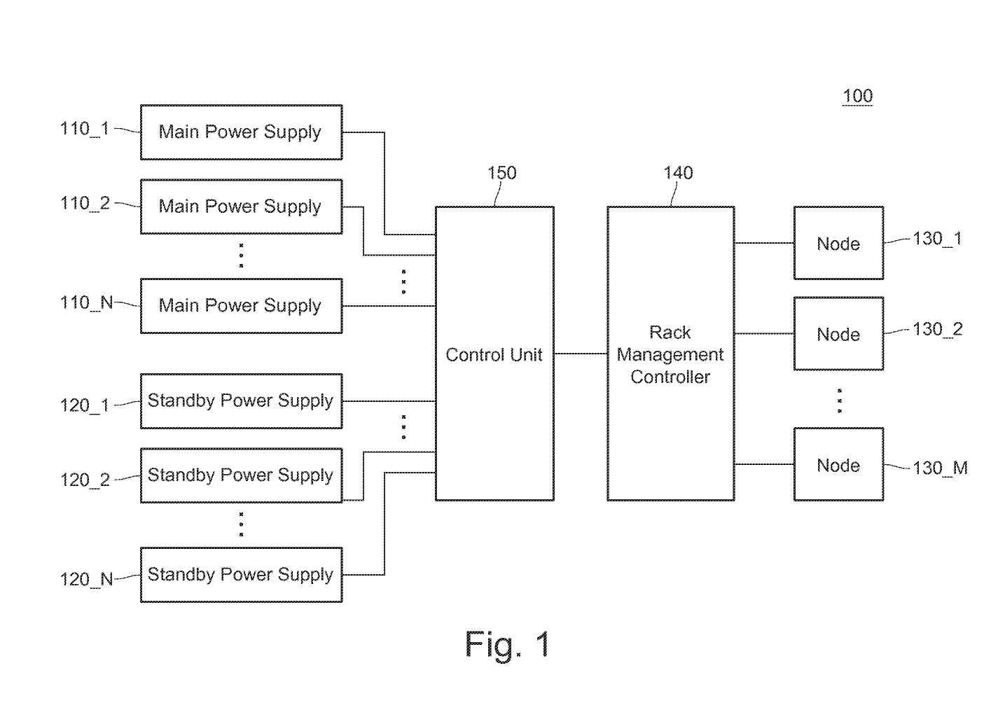

FIG. 1 is a schematic diagram of a rack in this disclosure. The rack 100 includes a plurality of main power supplies 110_1 to 110_N, a plurality of standby power supplies 120_1 to 120_N, a plurality of nodes 130_1 to 130_M, a rack management controller

(RMC) 140 and a control unit 150, where N and M are integers greater than 1 and are equal or different.

The main power supplies 110_1 to 110_N are used for respectively supplying operating voltages, for example, the main operating voltages required by the rack 100 when the main power supplies 110_1 to 110_N operate normally.

The standby power supplies 120_1 to 120_N are used for respectively supplying the operating voltages, for example, the standby operating voltages required by the rack 100 when the standby power supplies 120_1 to 120_N operate normally. In other words, when all of the main power supplies 110_1 to 110_N malfunction, the standby power supplies 120_1 to 120_N supply the operating voltages to the rack 100, so that the rack 100 can still operate normally.

In this embodiment, the maximum power values that each of the main power supplies 110_1 to 110_N and each of the standby power supplies 120_1 to 120_N can provide are the same, for example, 500 W. Furthermore, the input source received by the main power supplies 110_1 to 110_N is different from that received by the standby power supplies 120_1 to 120_N. For example, the input source received by the main power supplies 110_1 to 110_N is a mains supply, and the input source received by the standby power supplies 120_1 to 120_N is a battery or other energy storage elements.

The nodes 130_1 to 130_M are used for providing their power information respectively. Specifically, each of the nodes 130_1 to 130_M, for example, includes a baseboard management controller (BMC) and a connection interface. The baseboard management controller is used for detect the operating states of the nodes 130_1 to 130_M, so as to provide the power information of the nodes 130_1 to 130_M. The power information can be the voltage, current and power consumption of the nodes 130_1 to 130_M. The connection interface can be an inter-integrated circuit (I2C) bus, a serial peripheral interface (SPI) bus, and a general purpose input/output (GPIO).

The rack management controller 140 can be coupled to the baseboard management controllers in the coupling nodes 130_1 to 130_M through the connection interfaces, so as to receive the power information namely the voltage, current and power consumption of the nodes 130_1 to 130_M), and to calculate a total power consumption value required by the nodes 130_1 to 130_M, according to the power information.

The rack management controller 140 then calculates a number of power supply needed to be turned on, according to the total power consumption value and a maximum power value of one power supply. The maximum power value for one power supply can be 500 W. Specifically, the number of power supply needed to be turned on is, for example, resulted by dividing the total power consumption value with the maximum power value.

In one embodiment, assume that the total power consumption value is 1400 W, and the maximum power value is 500 W. The rack management controller 140 uses the total power consumption value and the maximum power value to obtain a value of 2.8 (1400 W/500 W=2.8), that is, 2.8 power supplies should be turned on. However, 0.8 power supply cannot be realized in practice. Herein, the rack management controller 140 considers the number of power supply needed to be turned on, which is less than 1, as 1, so that the number of power supply needed to be turned on is rounded up to 3.

In another embodiment, assume that the total power consumption value is 1600 W, and the maximum power value is 500 W. The rack management controller 140 uses the total power consumption value and the maximum power value to obtain a value of 3.2 (1600 W/500 W=3.2), that is, 3.2 power supplies should be turned on. Thus, the number of power supply needed to be turned on, which is calculated by the rack management controller 140, is 4.

Subsequently, the rack management controller 140 calculates an actual number of power supply needed to be turned on, according to the number of power supply needed to be turned on. The actual number of power supply needed to be turned on is greater than the number of power supply needed to be turned on. In this embodiment, the number of power supply needed to be turned on is N, and the actual number of power supply needed to be turned on is N+1.

For example, while the number of power supply needed to be turned on is 3, the actual number of power supply needed to be turned on is 4. In another example, while the number of power supply needed to be turned on is 4, the actual number of power supply needed to be turned on is 5. The rest can be deduced by analogy.

The control unit 150 is coupled with the rack management controller 140, the main power supplies 110_1 to 110_N and the standby power supplies 120_1 to 120_N, for receiving the actual number of power supply needed to be turned on, and then for generating a plurality of control signals, so as to turn on a plurality of main power supplies and standby power supplies in pairs. In this embodiment, the control unit 150 is, for example, a complex programming logic device (CPLD).

For example, when the number of power supply needed to be turned on, which is calculated by the rack management controller 140, is 1 and then the actual number of power supply needed to be turned on is 2. Herein, the control unit 150 outputs a corresponding number of control signals to the main power supplies 110_1 and 110_2 and the standby power supplies 120_1 and 120_2, so as to turn them on.

In another example, when the number of power supply needed to be turned on, which is calculated by the rack management controller 140, is 2, the actual number of power supply needed to be turned on is 3. Herein, the control unit 150 outputs a corresponding number of control signals to the main power supplies 110_1 to 110_3 and the standby power supplies 120_1 to 120_3, so as to turn them on. The rest are deduced by analogy. In this way, the control unit 150 turns on the power supplies in pairs, that is, the main power supply and the standby power supply are turned on simultaneously.

Further, the control signals include, for example, a turn-on signal DC_ON and a power supplying signal DC_Rapidon. The turn-on signal DC_ON is used for controlling whether to turn on the power supply. For example, when the turn-on signal DC_ON is at a low logic level, the power supply is turned on; otherwise, the power supply is turned off. The power supplying signal DC_Rapidon is used for controlling whether the power supply supplies power or not. For example, when the power supplying signals DC_Rapidon are at a high logic level, the power supplies respectively supply a high voltage, e.g., 12.2V, to support the operations of the nodes 130_1 to 130_M. Otherwise, the power supplies respectively supply a low voltage, e.g., 11.9V, so that the nodes 130_1 to 130_M do not operate according to the low voltages.

For example, when the number of power supply needed to be turned on is 1 and the actual number of power supply needed to be turned on is 2, the control unit 150 correspondingly outputs the turn-on signals DC_ON at the low logic level and the power supplying signals DC_Rapidon at the high logic level to the main power supplies 110_1 and 110_2, and outputs the turn-on signals DC_ON at the low logic level and the power supplying signals DC_Rapidon at the low logic level to the standby power supplies 120_1 and 120_2, so as to turn on the main power supplies 110_1 and 110_2 and the standby power supplies 120_1 and 120_2. Herein, the main power supplies 110_1 and 110_2 respectively supply the high voltage to support the operations of the nodes 130_1 to 130_M, and the standby power supplies 120_1 and 120_2 respectively supply the low voltage as a standby power.

On the other hand, the control unit 150 correspondingly outputs the turn-on signals DC_ON at the high logic level to the main power supplies 110_3 to 110_N and the standby power supplies 120_3 to 120_N, so as to turn off the main power supplies 110_3 to 110_N and the standby power supplies 120_3 to 120_N.

To support the power consumption required by the nodes 130_1 to 130_M in the rack 100, the main power supplies and the standby power supplies, for example, the main power supplies 110_1 and 110_2 and the standby power supplies 120_1 and 120_2, are correspondingly required to be turned on in pairs according to the number of power supply needed to be turned on, which is calculated by the rack management controller 140. Herein, the control unit 150 can further turn on the main power supplies and the standby power supplies, for example, the main power supplies 110_1 to 110_3 and the standby power supplies 120_1 to 120_3 in pairs, according to the actual number of power supply needed to be turned on, which is greater than the number of power supply needed to be turned on. This may reduce the load of the three main power supplies 110_1 to 110_3 to about 50%, thereby increasing the conversion efficiency and the power conservation.

On the other hand, the control unit 150 correspondingly turns on the main power supplies and the standby power supplies, for example, the main power supplies 110_1 to 110_3 and the standby power supplies 120_1 to 120_3, according to the actual number of power supply needed to be turned on, which is greater than the number of power supply needed to be turned on, so that when tone of the main power supplies 110_1 to 110_3, for example, the main power supply 110_2, malfunctions, the rest of the main power supplies (e.g. the main power supplies 110_1 and 110_3) can still supply the operating voltages for the power consumption of the nodes 130_1 to 130_M, and the rack 100 can still operate normally.

In another embodiment, when the number of power supply needed to be turned on is 2, the control unit 150 correspondingly outputs the turn-on signals DC_ON at the low logic level and the power supplying signals DC_Rapidon at the high logic level to the main power supplies 110_1 and 110_2, and outputs the turn-on signals DC_ON at the low logic level and the power supplying signals DC_Rapidon at the low logic level to the standby power supplies 120_1 and 120_2, so as to turn on the main power supplies 110_1 and 110_2 and the standby power supplies 120_1 and 120_2. Herein, the main power supplies 110_1 and 110_2 supply the high voltages, and the standby power supplies 120_1 and 120_2 supply the low voltages. Therefore, the nodes 130_1 to 130_M operate according to the high voltages supplied by the main power supplies 110_1 and 110_2, and take the low voltages as a backup power.

In addition, the control unit 150 correspondingly outputs the turn-on signals DC_ON at the high logic level to the main power supplies 110_3 to 110_N and the standby power supplies 120_3 to 120_N, so as to turn off the main power supplies 110_3 to 110_N and the standby power supplies 120_3 to 120_N. In this way, the rest can be deduced by analogy. Thus, the disclosure may increase the power conservation.

After turning on the main power supplies 110_1 to 110_N and the standby power supplies 120_1 to 120_N, the main power supplies 110_1 to 110_N and the standby power supplies 120_1 to 120_N respectively response a power-good signal to the control unit 150. The power-good signals represents whether the main power supplies 110_1 to 110_N and the standby power supply 120_1 to 120_N operate normally or not. Subsequently, the control unit 150 can determine whether the main power supplies 110_1 to 110_N and the standby power supplies 120_1 to 120_N operate normally or not, according to the power-good signals.

For example, the power-good signals at the high logic level represent that the main power supplies 110_1 to 110_N and the standby power supplies 120_1 to 120_N operate normally, and the power-good signals at the low logic level represent that the main power supplies 110_1 to 110_N and the standby power supplies 120_1 to 120_N operate abnormally.

Provided that the control unit 150 receives a power-good signals at the low logic level from the main power supply 110_2 after the main power supplies 110_1 to 110_3 is turned on, which indicates that the main power supply 110_2 malfunctions or is damaged. Herein, the control unit 150 responses a signal relating to the malfunction situation to the rack management controller 140, and generates the control signals, for example, the turn-on signal DC_ON at the low logic level and the power supplying signal DC_Rapidon at the high logic level, to the main power supply 110_4, so as to turn on the main power supply 110_4.

However, if the control unit 150 receives the power-good signal at the low logic level from the main power supply 110_4, this indicates that the main power supply 110_4 malfunctions or is damaged. Herein, the control unit 150 also response a signal relating to the malfunction situation to the rack management controller 140, and generates the control signals, for example, the turn-on signal DC_ON at the low logic level and the power supplying signal DC_Rapidon at the high logic level, to the main power supply 110_5, so as to turn on the main power supply 110_5. The rest can be deduced by analogy.

Moreover, when discovering that any of the main power supplies 110_1 to 110_N malfunctions, the control unit 150 further determines whether the main power supply malfunctioning is the last one of the main power supplies 110_1 to 110_N, namely the main power supply 110_N. If the main power supply malfunctioning is not the last one of the main power supplies 110_1 to 110_N, the control unit 150 correspondingly generates control signals, so as to turn on the next main power supply. If the main power supply malfunctioning is the last one of the main power supplies 110_1 to 110_N, the control unit 150 outputs the power supplying signal DC_Rapidon at the high logic level to the standby power supply 120_1, to enable the standby power supply 120_1 to supply the high voltage. Thus, the rack 100 can still operate normally.

If an error, for example, the blackout, occurs on the input source received by the main power supply 110_1 to 110_N, the main power supplies 110_1 to 110_N can not receive the input source. Herein, the main power supplies 110_1 to 110_N correspondingly and respectively output a power-good signal at the low logic level. Therefore, when the control unit 150 learns that the power-good signals outputted by all the turned-on main power supplies 110_1 to 110_3 are at the low logic level, this indicates that all the turned-on main power supplies 110_1 to 110_3 malfunction. Herein, the control unit 150 outputs the power supplying signals DC_Rapidon at the high logic level to a corresponding number of the standby power supplies 120_1 to 120_3. The standby power supplies 120_1 to 120_3 supply the high voltages as the operating voltages required by the nodes 130_1 to 130_M. Thus, the rack 100 can still operate normally. In this way, it can avoid that the rack 100 cannot operate when the power supplies malfunction.

Moreover, if the control unit 150 learns that all of the power-good signals outputted by all the turned-on main power supplies are not at the low logic level, the operation can refer to the foregoing description relating to the main power supply 110_2 malfunctioning, thereby being not described again here.

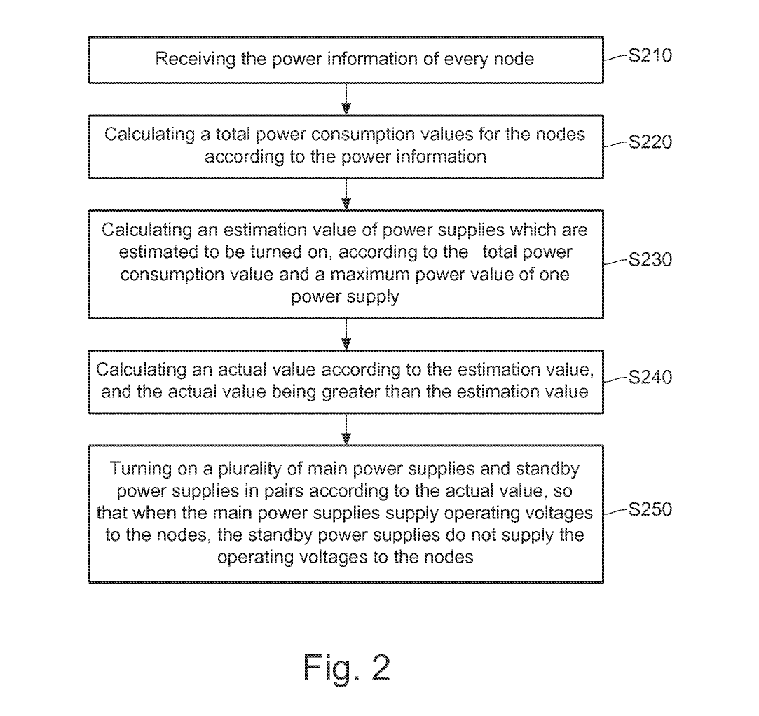

According to the foregoing description of the embodiments, a power control method for a rack can be concluded in FIG. 2. FIG. 2 is a flowchart of a power control method of this disclosure. The rack of this embodiment includes a plurality of nodes. This method includes the following steps. In step S210, power information for every node is provided. In step S220, a total power consumption value for the nodes is calculated according to the power information. In step S230, a number of power supply needed to be turned on is calculated according to the total power consumption value and a maximum power value of one power supply. The number of power supply needed to be turned on is equal to the total power consumption value divided by the maximum power value. In step S240, an actual number of power supply needed to be turned on is calculated according to the number of power supply needed to be turned on. The actual number of power supply needed to be turned on is greater than the number of power supply needed to be turned on.

In step S250, a plurality of main power supplies and standby power supplies are turned on in pairs according to the actual number of power supply needed to be turned on, so that when the turned-on main power supplies supply operating voltages to the nodes, the turned-on standby power supplies do not supply the operating voltages to the nodes. The input source received by the main power supplies is different from that received by the standby power supplies. In this embodiment, the number of power supply needed to be turned on is N, and the actual number of power supply needed to be turned on is N+1, wherein N is an integer greater than 1.

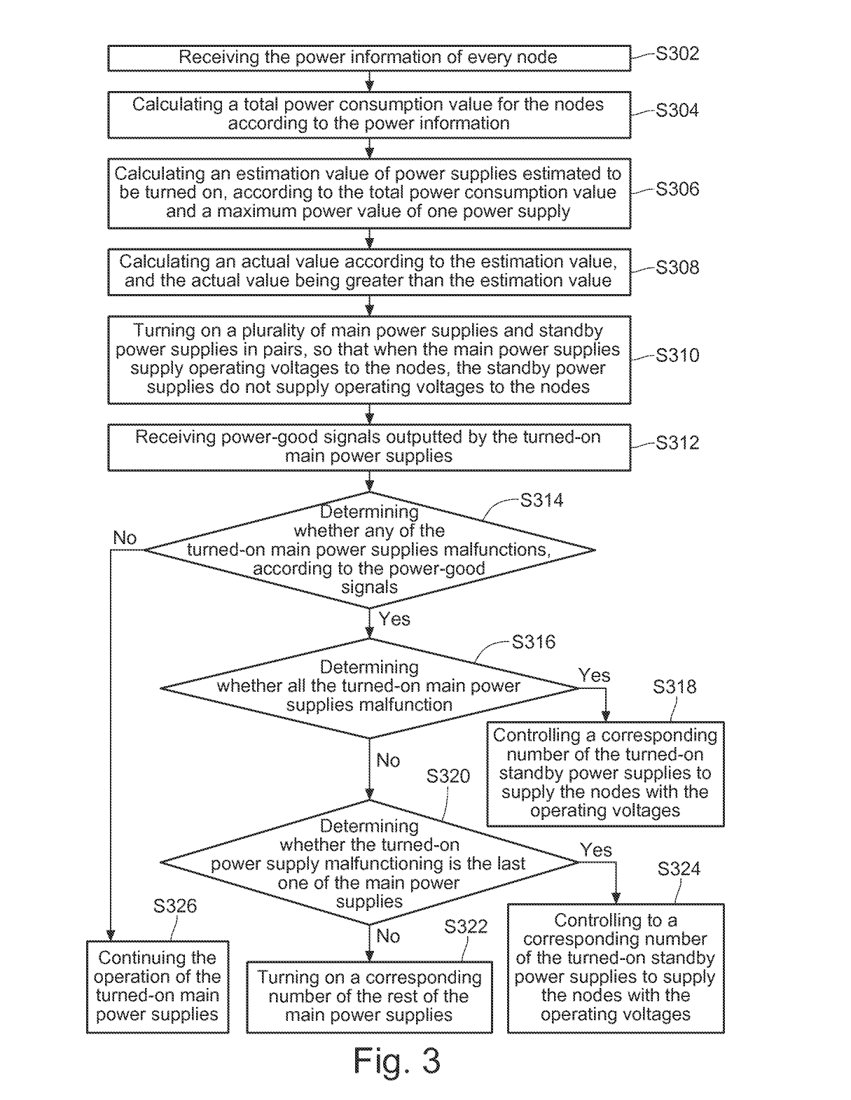

FIG. 3 is a flowchart of another power control method of this disclosure. The rack includes a plurality of nodes. This method includes following steps. In step S302, power information for every node is received. In step S304, a total power consumption value for the nodes is calculated according to the power information. In step S306, a number of power supply needed to be turned on is calculated according to the total power consumption value and a maximum power value of one power supply.

In step S308, an actual number of power supply needed to be turned on is calculated according to the number of power supply needed to be turned on. The actual number of power supply needed to be turned on is greater than the number of power supply needed to be turned on. In step S310, a plurality of main power supplies and standby power supplies are turned on in pairs, so that when the turned-on main power supplies supply operating voltages to the nodes, the turned-on standby power supplies do not supply the operating voltages to the nodes.

In step S312, the power-good signals outputted by the turned-on main power supplies are received. In step S314, it is performed to determine whether any of the turned-on main power supplies malfunctions.

If at least one of the turned-on main power supplies malfunctions, it is further performed in step S316 to determine whether all the turned-on main power supplies malfunction. If all the turned-on main power supplies malfunction, a corresponding number of the standby power supplies are controlled to supply the nodes with the operating voltages in step S318. On the other hand, if all the turned-on main power supplies do not malfunction, it is further performed in step S320 to determine whether the turned-on power supply malfunctioning is the last one of the main power supplies. If the turned-on power supply malfunctioning is not the last one of the main power supplies, a corresponding number of the rest of the main power supplies are turned on in step S322.

If the turned-on main power supply malfunctioning is the last one of the main power supplies, the corresponding number of the standby power supplies are controlled to supply the nodes with the operating voltages in step S324. If the turned-on main power supplies do not malfunction in step S314, the turned-on main power supplies operate continuously.

The rack and the power control method thereof in the disclosure calculate the total power consumption value for the nodes according to the power information provided by the nodes, calculate the number of power supply needed to be turned on , according to the total power consumption value and the maximum power value of one power supply, calculate the actual number of power supply needed to be turned on according to the number of power supply needed to be turned on, and turn on a corresponding number of the main power supplies and the standby power supplies in pairs. The actual number of power supply needed to be turned on is greater than the number of power supply needed to be turned on. In this way, the load of power supplies may be efficiently reduced, and the power conversion efficiency and the power conservation may be increased, thereby avoiding which the rack cannot operate when some power supplies malfunction.

What is claimed is:

1. A power control method for a rack having a plurality of nodes, comprising:
receiving power information of each of the plurality of nodes;
calculating a total power consumption value for the plurality of nodes, according to the power information;
calculating a number of power supply needed to be turned on, according to the total power consumption value and a maximum power value of one power supply;
calculating an actual number of power supply needed to be turned on, according to the number of power supply needed to be turned on, wherein the actual number of power supply needed to be turned on is greater than the number of power supply needed to be turned on; and
turning on a plurality of main power supplies and standby power supplies in pairs according to the actual number of power supply needed to be turned on;
wherein while the turned-on main power supplies supply a plurality of operating voltages to the plurality of nodes, the turned-on standby power supplies do not supply the plurality of operating voltages to the plurality of nodes, and an input source received by the plurality of main power supplies is different from an input source received by the plurality of standby power supplies.

2. The power control method according to claim 1, wherein the number of power supply needed to be turned on is N, the actual number of power supply needed to be turned on is N+1, and N is an integer greater than 1.

3. The power control method according to claim 1, further comprising:
receiving a plurality of power-good signals generated by the turned-on main power supplies;
determining whether any of the turned-on main power supplies malfunctions, according to the plurality of power-good signals; and
turning on a corresponding number of other main power supplies if at least one of the turned-on main power supplies malfunctions.

4. The power control method according to claim 3, further comprising:
determining whether the at least one turned-on main power supply malfunctioning is the last one of the turned-on main power supplies;
turning on the corresponding number of the other main power supplies if the at least one turned-on main power supply is not the last one of the turned-on main power supplies; and
controlling the corresponding number of the turned-on standby power supplies to supply the plurality of operating voltages to the plurality of nodes if the at least one turned-on main power supply is the last one of the turned-on main power supplies.

5. The power control method according to claim 4, further comprising:
determining whether all of the turned-on main power supplies malfunction;
controlling a corresponding number of the turned-on standby power supplies to supply the plurality of operating voltages to the plurality of nodes if all of the turned-on main power supplies malfunction; and
performing the step of determining whether the at least one turned-on main power supply is the last one of the turned-on main power supplies, if all of the turned-on main power supplies do not malfunction.

6. A rack, comprising:
a plurality of main power supplies, for supplying operating voltages;
a plurality of standby power supplies, for supplying the operating voltages, wherein an input source received by the plurality of main power supplies is different from an input source received by the plurality of standby power supplies, and the plurality of standby power supplies pair with the plurality of main power supplies respectively;
a plurality of nodes, for providing their power information respectively;
a rack management controller, coupled with the plurality of nodes, for receiving the power information to calculate a total power consumption value for the plurality of nodes, for calculating a number of power supply needed to be turned on, according to the total power consumption value and a maximum power value of one power supply, and for calculating an actual number of power supply needed to be turned on according to the number of power supply needed to be turned on, wherein the actual number of power supply needed to be turned on is greater than the number of power supply needed to be turned on; and
a control unit, coupled with the rack management controller, the plurality of main power supplies and the plurality of standby power supplies, for receiving the actual number of power supply needed to be turned on, to generate a plurality of control signals, so as to turn on the plurality of main power supplies and the plurality of standby power supplies in pairs, wherein when the turned-on main power supplies supply the operating voltages to the plurality of nodes, the turned-on standby power supplies do not supply the operating voltages to the plurality of nodes.

7. The rack according to claim 6, wherein the number of power supply needed to be turned on is N, the actual number of power supply needed to be turned on is N+1, and N is an integer greater than 1.

8. The rack according to claim 6, wherein the plurality of main power supplies and the plurality of standby power supplies respectively output a power-good signal to the control unit after being turned on, the control unit determines whether at least one of the turned-on main power supplies malfunctions, according to the power-good signals, and if the at least one turned-on main power supply malfunctions, the control unit turns on a corresponding number of the rest of the plurality of main power supplies.

9. The rack according to claim 8, wherein the control unit further determines whether the at least one turned-on main power supply malfunctioning is the last one of the plurality of main power supplies, the control unit turns on the corresponding number of the rest of the plurality of main power supplies if the at least one turned-on main power supply malfunctioning is not the last one of the plurality of main power supplies, and the control unit controls the corresponding number of the turned-on standby power supplies to supply the operating voltages to the plurality of nodes if the at least one turned-on main power supply malfunctioning is the last one of the plurality of main power supplies.

10. The rack according to claim 9, wherein the control unit further determines whether all of the turned-on main power supplies malfunction; the control unit controls the corresponding number of the turned-on standby power supplies to supply the operating voltages to the plurality of nodes if all of the turned-on main power supply malfunction; and the control unit determines whether the at least one turned-on power supply malfunctioning is the last one of the plurality of main power supplies if all of the turned-on main power supplies do not malfunction, so as to turn on the corresponding number of the rest of the plurality of main power supplies, or to control the corresponding number of the turned-on standby power supplies to supply the operating voltages to the plurality of nodes.
